(19) United States
(12) Patent Application Publication
(10) Pub. No.: US 2012/0162823 A1
(43) Pub. Date: Jun. 28, 2012

(54) RECORDING HEAD AND DISK DRIVE WITH THE SAME

(75) Inventors: Toshiyuki IKAI, Ome-shi (JP); Tomoko Taguchi, Kunitachi-shi (JP)

(73) Assignee: Kabushiki Kaisha Toshiba, Tokyo (JP)

(21) Appl. No.: 13/250,819

(22) Filed: Sep. 30, 2011

(30) Foreign Application Priority Data
Dec. 24, 2010 (JP) 2010-288827

(51) Int. Cl. G11B 5/33; G11B 5/60

(52) U.S. Cl. 360/234.3; 360/111; G9B/5.104; G9B/5.229

(57) ABSTRACT

According to one embodiment, a recording head for perpendicular recording, includes a main pole configured to apply a recording magnetic field to a recording layer of a recording medium, a return pole opposed to the main pole with a write gap therebetween and configured to form a magnetic circuit in conjunction with the main pole, a junction formed of a nonmagnetic body in which soft magnetic bodies are dispersed and configured to physically connect the main and return poles to each other, a coil configured to excite the magnetic flux in the magnetic circuit, a spin-torque oscillator arranged between the return pole and an end portion of the main pole and configured to produce a high-frequency magnetic field, and a current source configured to supply a current to the spin-torque oscillator through the return and main poles.

### CROSS-REFERENCE TO RELATED APPLICATIONS

This application is based upon and claims the benefit of priority from prior Japanese Patent Application No. 2010-288827, filed Dec. 24, 2010, the entire contents of which are incorporated herein by reference.

### FIELD

Embodiments described herein relate generally to a recording head for perpendicular magnetic recording used in a disk drive and the disk drive provided with the recording head.

### BACKGROUND

A disk drive, such as a magnetic disk drive, comprises a magnetic disk, spindle motor, magnetic head, and carriage assembly. The magnetic disk is arranged in a case. The spindle motor supports and rotates the disk. The magnetic head reads data from and writes data to the disk. The carriage assembly supports the head for movement relative to the disk. The carriage assembly comprises a pivotably supported arm and a suspension extending from the arm, and the magnetic head is supported on an extended end of the suspension. The head comprises a slider mounted on the suspension and a head section arranged on the slider. The head section comprises a recording head for writing and a reproduction head for reading.

Recording heads for perpendicular magnetic recording with a spin-torque oscillator have recently been proposed in order to increase the recording density and capacity of a magnetic disk drive or reduce its size. One such recording head comprises a main pole configured to produce a perpendicular magnetic field, return or write/shield pole, and coil. The return pole is located on the trailing side of the main pole with a write gap therebetween and configured to close a magnetic path that leads to a magnetic disk. The coil serves to pass magnetic flux through the main pole. The spin-torque oscillator is arranged between the return pole and the distal end portion of the main pole.

In oscillating the spin-torque oscillator in the recording head of this type, a direct current must be supplied between the main and return poles arranged so that the oscillator is sandwiched between them. To this end, a nonmagnetic material is used to form a rear junction that connects the respective rear parts of the main and return poles and is wound with the coil.

Since the nonmagnetic material is not a soft magnetic material, however, a magnetic gap is formed at the rear junction, thereby causing a magnetic field loss, in a magnetic circuit formed of the main and return poles. Accordingly, a gap magnetic field between the return and main poles that acts on the spin-torque oscillator is reduced, so that a desired leakage magnetic field that is applied during recording operation is also reduced. Consequently, a satisfactory recording state for a recording medium cannot be easily achieved, so that recording quality signal-to-noise ratio is degraded, and it becomes difficult to increase the linear recording density of the magnetic disk.

Further proposed is a recording head in which a rear junction consists mainly of an electrically insulating ferromagnetic oxide such as ferrite. The saturated magnetic flux density of an oxide magnetic material is as low as a quarter to a half that of a soft magnetic metallic material. To achieve sufficient magnetic field strength, the volume of the rear junction must be increased. If this is done, however, it becomes necessary to elongate the coil wound on the rear junction. In performing high-transfer magnetic recording, therefore, the response speed is not sufficiently high, so that the quality of recording on the recording medium is degraded, and the linear recording density of the magnetic disk cannot be increased.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing a hard disk drive (HDD) according to a first embodiment;

FIG. 2 is an exemplary side view showing a magnetic head and suspension of the HDD;

FIG. 3 is an exemplary enlarged sectional view showing a head section of the magnetic head and a magnetic disk;

FIG. 4 is an exemplary enlarged sectional view showing an ABS-side end portion of the recording head;

FIG. 5 is an exemplary perspective view schematically showing the recording head;

FIG. 6 is an exemplary plan view of the recording head taken from the leading side;

FIG. 7 is an exemplary plan view of a recording head section taken from the ABS side of a slider;

FIG. 8 is an exemplary cutaway perspective view of the recording head;

FIG. 9 is an exemplary enlarged sectional view showing a junction of the recording head;

FIG. 10 is an exemplary diagram comparatively showing bit-error rates for a magnetic head according to Comparative Example 1 and the magnetic head according to the first embodiment;

FIG. 11 is an exemplary diagram comparatively showing bit-error rates for a magnetic head according to Comparative Example 2 and the magnetic head according to the first embodiment;

FIG. 12 is an enlarged sectional view showing a junction of a recording head of an HDD according to a second embodiment;

FIG. 13 is an exemplary cutaway perspective view showing a recording head of an HDD according to a third embodiment; and

FIG. 14 is an exemplary enlarged sectional view showing a junction of the recording head of the HDD of the third embodiment.

### DETAILED DESCRIPTION

Various embodiments will be described hereinafter with reference to the accompanying drawings.

In general, according to one embodiment, a recording head for perpendicular recording, comprises a main pole configured to apply a recording magnetic field to a recording layer of a recording medium; a return pole opposed to the main pole with a write gap therebetween and configured to form a magnetic circuit in conjunction with the main pole; a junction formed of a nonmagnetic body in which soft magnetic bodies are dispersed and configured to physically connect the main and return poles to each other; a coil configured to excite the magnetic flux in the magnetic circuit; a spin-torque oscillator arranged between the return pole and an end portion of the main pole and configured to produce a high-frequency magnetic field; and a current source configured to supply a current to the spin-torque oscillator through the return and main poles.

### First Embodiment

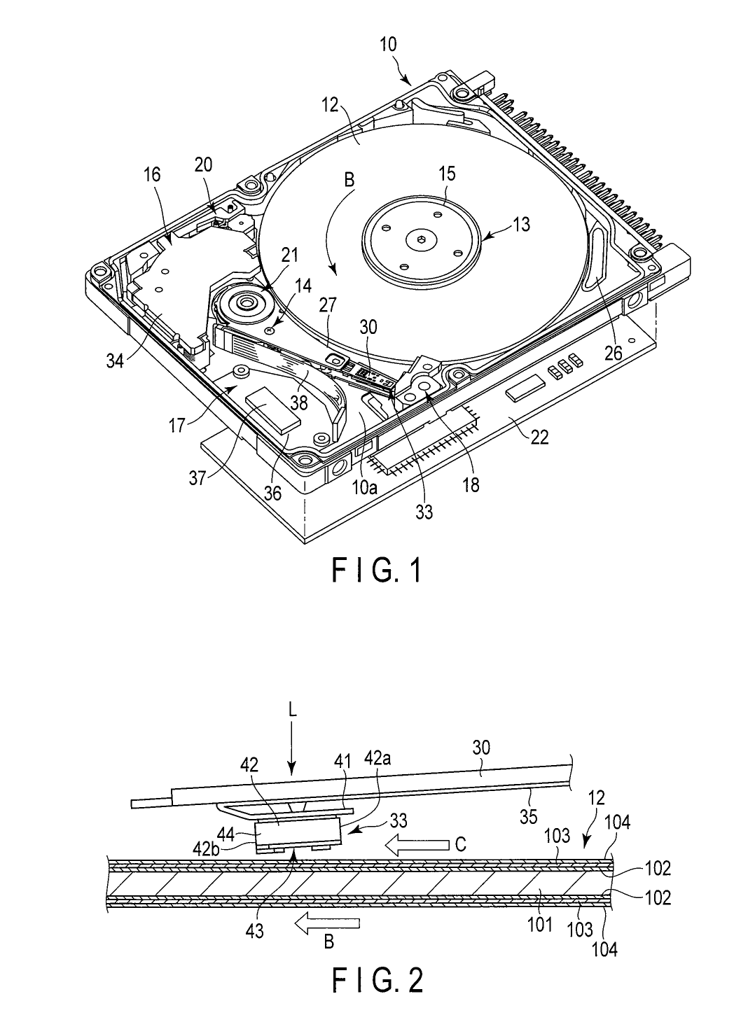

FIG. 1 shows the internal structure of an HDD according to a first embodiment with its top cover removed, and FIG. 2 shows a flying magnetic head. As shown in FIG. 1, the HDD comprises a housing 10. The housing 10 comprises a base 10a in the form of an open-topped rectangular box and a top cover (not shown) in the form of a rectangular plate. The top cover is attached to the base by screws such that it closes the top opening of the base. Thus, the housing 10 is kept airtight inside and can communicate with the outside through a breather filter 26 only.

The base 10a carries thereon a magnetic disk 12, for use as a recording medium, and a mechanical unit. The mechanical unit comprises a spindle motor 13, a plurality (e.g., two) of magnetic heads 33, head actuator 14, and voice coil motor (VCM) 16. The spindle motor 13 supports and rotates the magnetic disk 12. The magnetic heads 33 record data on and reproduce data from the disk 12. The head actuator 14 supports the heads 33 for movement relative to the surfaces of the disk 12. The VCM 16 pivots and positions the head actuator. The base 10a further carries a ramp loading mechanism 18, latch mechanism 20, and board unit 17. The ramp loading mechanism 18 holds the magnetic heads 33 in a position off the magnetic disk 12 when the heads are moved to the outermost periphery of the disk. The latch mechanism 20 holds the head actuator 14 in a retracted position if the HDD is jolted, for example. Electronic components, such as a preamplifier, head IC, etc., are mounted on the board unit 17.

A control circuit board 22 is attached to the outer surface of the base 10a by screws such that it faces a bottom wall of the base. The circuit board 22 controls the operations of the spindle motor 13, VCM 16, and magnetic heads 33 through the board unit 17.

As shown in FIG. 1, the magnetic disk 12 is coaxially mounted on the hub of the spindle motor 13 and clamped and secured to the hub by a clamp spring 15, which is attached to the upper end of the hub by screws. The disk 12 is rotated at a predetermined speed in the direction of arrow B by the spindle motor 13 for use as a drive motor.

The head actuator 14 comprises a bearing 21 secured to the bottom wall of the base 10a and a plurality of arms 27 extending from the bearing. The arms 27 are arranged parallel to the surfaces of the magnetic disk 12 and at predetermined intervals and extend in the same direction from the bearing 21. The head actuator 14 comprises elastically deformable suspensions 30 each in the form of an elongated plate. Each suspension 30 is formed of a plate spring, the proximal end of which is secured to the distal end of its corresponding arm 27 by spot welding or adhesive bonding and which extends from the arm. Each suspension 30 may be formed integrally with its corresponding arm 27. The magnetic heads 33 are supported individually on the respective extended ends of the suspensions 30. Each arm 27 and its corresponding suspension 30 constitute a head suspension, and the head suspension and each magnetic head 33 constitute a head suspension assembly.

As shown in FIG. 2, each magnetic head 33 comprises a substantially cuboid slider 42 and read/write head section 44 on an outflow end (trailing end) of the slider. Each head 33 is secured to a gimbal spring 41 on the distal end portion of each corresponding suspension 30. A head load L directed to the surface of the magnetic disk 12 is applied to each head 33 by the elasticity of the suspension 30. The two arms 27 are arranged parallel to and spaced apart from each other, and the suspensions 30 and heads 33 mounted on these arms face one another with the magnetic disk 12 between them.

Each magnetic head 33 is electrically connected to a main FPC 38 (described later) through a relay flexible printed circuit (FPC) board 35 secured to the suspension 30 and arm 27.

As shown in FIG. 1, the board unit 17 comprises an FPC main body 36 formed of a flexible printed circuit board and the main FPC 38 extending from the FPC main body. The FPC main body 36 is secured to the bottom surface of the base 10a. The electronic components, including a preamplifier 37 and head IC, are mounted on the FPC main body 36. An extended end of the main FPC 38 is connected to the head actuator 14 and also connected to each magnetic head 33 through each relay FPC 35.

The VCM 16 comprises a support frame (not shown) extending from the bearing 21 in the direction opposite to the arms 27 and a voice coil supported on the support frame. When the head actuator 14 is assembled to the base 10a, the voice coil is located between a pair of yokes 34 that are secured to the base 10a. Thus, the voice coil, along with the yokes and a magnet secured to the yokes, constitutes the VCM 16.

If the voice coil of the VCM 16 is energized with the magnetic disk 12 rotating, the head actuator 14 pivots, whereupon each magnetic head 33 is moved to and positioned on a desired track of the disk 12. As this is done, the head 33 is moved radially relative to the disk 12 between the inner and outer peripheral edges of the disk.

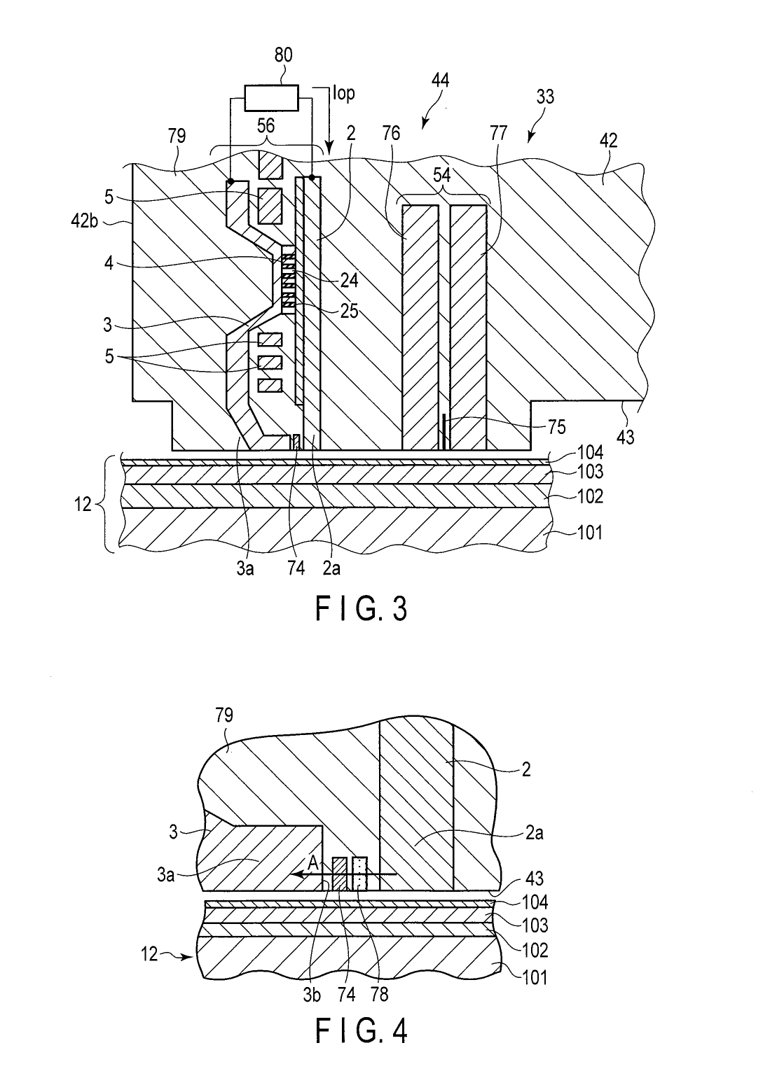

The following is a detailed description of configurations of the magnetic disk 12 and each magnetic head 33. FIG. 3 is an enlarged sectional view showing the magnetic disk and the head section 44 of the head 33.

As shown in FIGS. 1 to 3, the magnetic disk 12 comprises a substrate 101 formed of a nonmagnetic disk with a diameter of, for example, about 2.5 inches. A soft magnetic layer 102 for use as an underlayer of a material having soft magnetic properties is formed on each surface of the substrate 101. The soft magnetic layer 102 is overlain by a magnetic recording layer 103, which has a magnetic anisotropy perpendicular to the disk surface. A protective film layer 104 is formed on the recording layer 103.

As shown in FIGS. 2 and 3, the magnetic head 33 is formed as a flying head, and comprises the substantially cuboid slider 42 and the head section 44 formed on the outflow or trailing end of the slider. The slider 42 is formed of, for example, a sintered body (AlTic) containing alumina and titanium carbide, and the head section 44 is a thin film.

The slider 42 has a rectangular disk-facing surface or air-bearing surface (ABS) 43 configured to face a surface of the magnetic disk 12. The slider 42 is caused to fly by airflow C that is produced between the disk surface and the ABS 43 as the disk 12 rotates. The direction of airflow C is coincident with the direction of rotation B of the disk 12. The slider 42 is arranged on the surface of the disk 12 in such a manner that the longitudinal direction of the ABS 43 is substantially coincident with the direction of airflow C.

The slider 42 comprises leading and trailing ends 42a and 42b on the inflow and outflow sides, respectively, of airflow C. The ABS 43 of the slider 42 is formed with leading and trailing steps, side steps, negative-pressure cavity, etc., which are not shown.

As shown in FIG. 3, the head section 44 is formed as a dual-element magnetic head, comprising a reproduction head 54 and recording head 56 formed on the trailing end 42b of the slider 42 by thin-film processing.

The reproduction head 54 comprises a magnetic film 75 having a magnetoresistive effect and shield films 76 and 77 arranged on the trailing and leading sides, respectively, of the magnetic film such that they sandwich the magnetic film between them. The respective lower ends of the magnetic film 75 and shield films 76 and 77 are exposed in the ABS 43 of the slider 42.

The recording head 56 is located nearer to the trailing end 42b of the slider 42 than the reproduction head 54. The recording head 56 is constructed as a single-pole head comprising a return pole on the trailing end side.

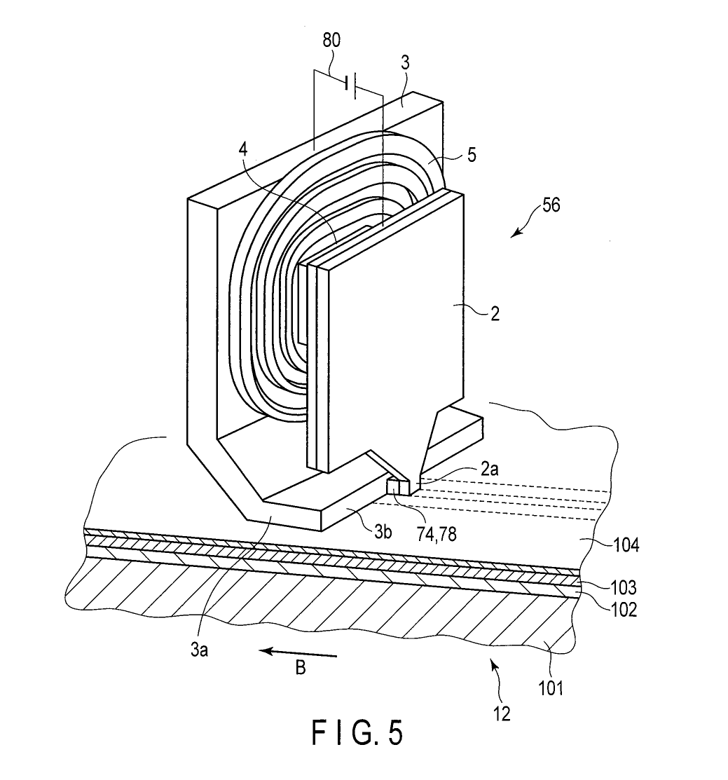

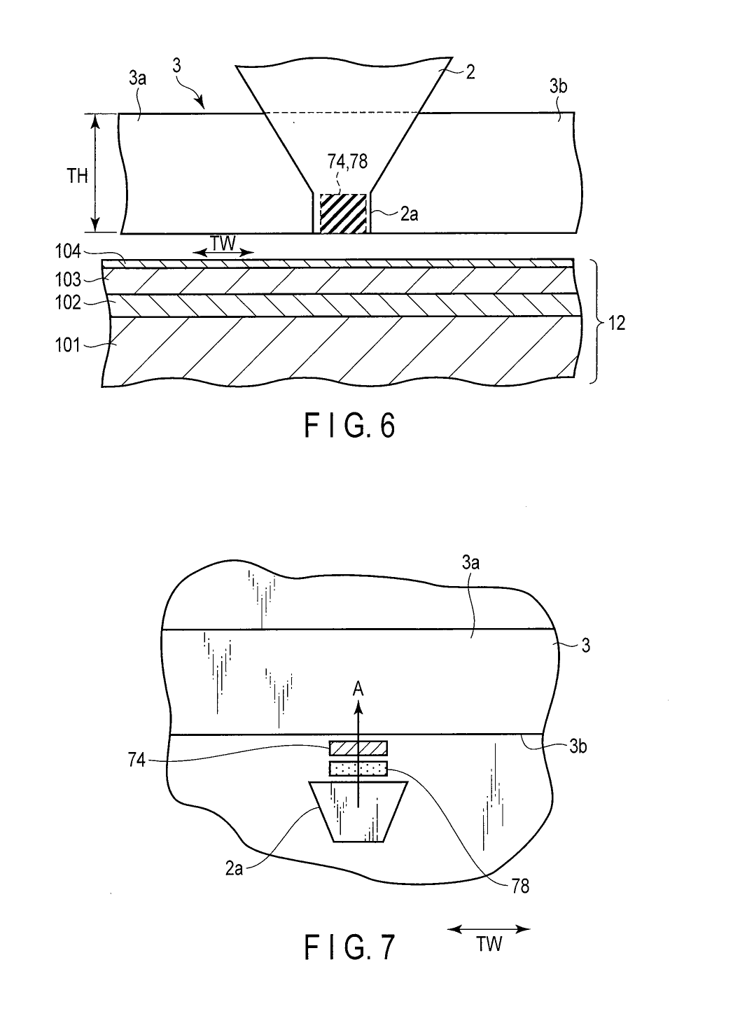

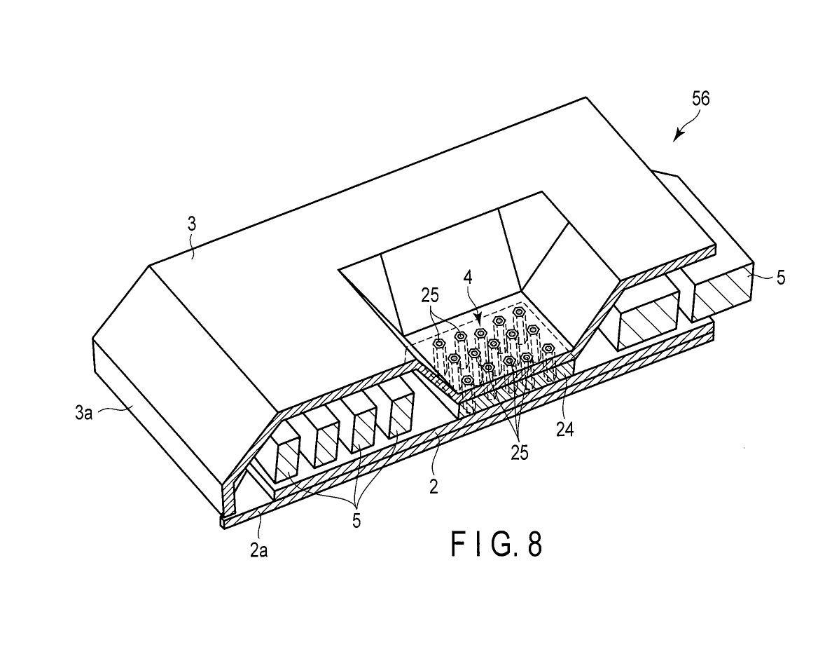

FIG. 4 is an enlarged sectional view showing an ABS-side end portion of the recording head, FIG. 5 is a perspective view schematically showing the recording head, and FIG. 6 is a plan view of the recording head taken from the leading side. FIG. 7 is a plan view of a recording head section taken from the ABS side of the slider, and FIG. 8 is a cutaway perspective view of the recording head.

As shown in FIGS. 3, 5 and 8, the recording head 56 comprises a magnetic core and recording coil 5. The magnetic core comprises a main pole 2, return pole 3, and junction 4. The main pole 2 has soft magnetic properties and produces a recording magnetic field perpendicular to the surfaces of the magnetic disk 12. The return pole 3 is arranged on the trailing side of the main pole 2 and serves to close a magnetic path with the aid of the soft magnetic layer 102 just below the main pole. The junction 4 connects respective upper or rear parts of the main and return poles separate from the ABS 43. The recording coil 5 is arranged such that it is wound around the magnetic path including the main and return poles 2 and 3 (or the junction 4 in this case) to pass magnetic flux to the main pole 2 while a signal is being recorded on the magnetic disk 12.

The main pole 2 extends substantially at right angles to the surfaces of the magnetic disk 12. A distal end portion 2a of the main pole 2 on the disk side is tapered toward the disk surface. The distal end portion 2a of the main pole 2 has, for example, a trapezoidal cross-section. The distal end surface of the main pole 2 is exposed in the ABS 43 of the slider 42.

The return pole 3 is substantially L-shaped and its distal end portion 3a has an elongated rectangular shape. The distal end surface of the return pole 3 is exposed in the ABS 43 of the slider 42. A leading end surface 3b of the distal end portion 3a extends transversely relative to the track of the magnetic disk 12. The leading end surface 3b is opposed parallel to the trailing end surface of the main pole 2 with a write gap therebetween.

A current source 80 is connected to the main and return poles 2 and 3, whereby a current circuit is constructed so that current Iop from the current source can be supplied in series through the poles 2 and 3.

As shown in FIGS. 4, 6 and 7, the recording head 56 comprises a high-frequency oscillator, e.g., a spin-torque oscillator 74, which is interposed between the return pole 3 and the distal end portion 2a of the main pole 2, and a spin injection layer 78 arranged for easier oscillation of the spin-torque oscillator. The oscillator 74 is located between and parallel to the trailing end surface of the distal end portion 2a of the main pole 2 and the leading end surface 3b of the return pole 3. The spin-torque oscillator 74 and spin injection layer 78 have their respective distal ends exposed in the ABS 43 and are disposed flush with the distal end surface of the main pole 2 with respect to the surface of the magnetic disk 12. Preferably, the length of the trailing end surface of the distal end portion 2a of the main pole 2 in the track width direction (TW) is greater than that of the oscillator 74.

Under the control of the control circuit board 22, the spin-torque oscillator 74 oscillates as it is supplied with current from the current source 80 through the main and return poles 2 and 3, thereby applying a high-frequency magnetic field to the magnetic disk 12. Thus, the main and return poles 2 and 3 serve as electrodes for perpendicular energization of the oscillator 74.

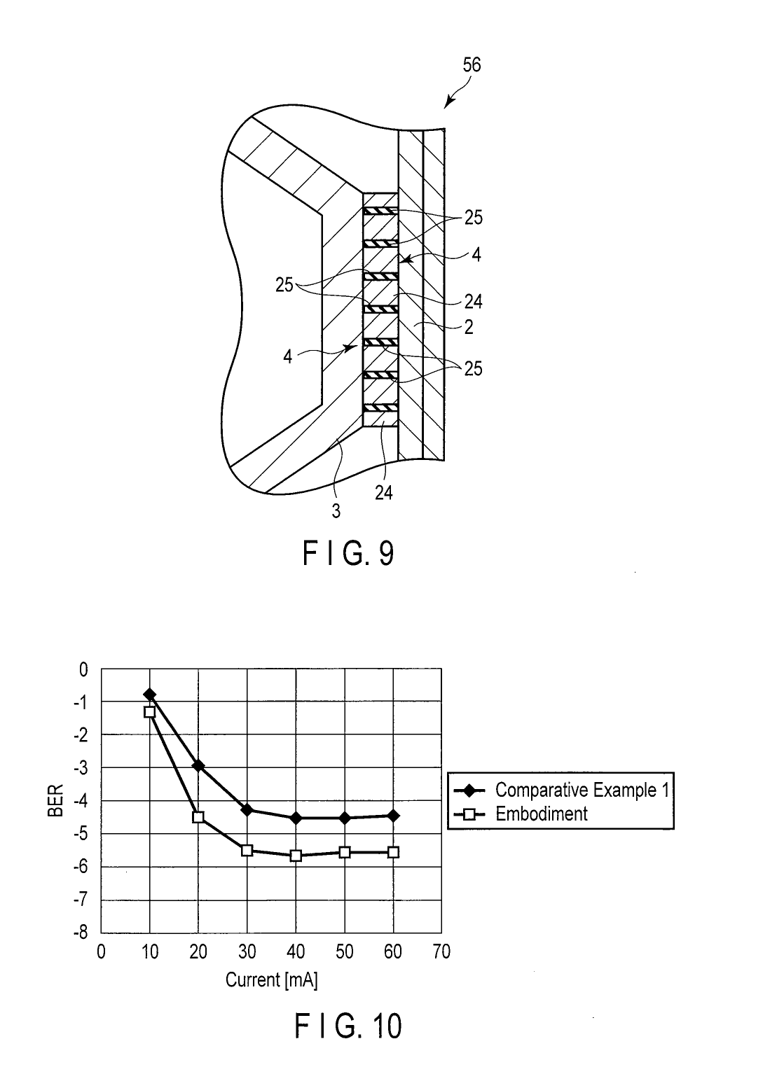

As shown in FIGS. 3, 8 and 9, the junction 4, which connects the respective upper or rear portions of the main and return poles 2 and 3, comprises a nonmagnetic insulating layer 24 and a large number of soft magnetic bodies 25. The insulating layer 24 is arranged between and in surface contact with the main and return poles 2 and 3 and physically connects the poles. The soft magnetic bodies 25 are included in the insulating layer 24. In the present embodiment, the soft magnetic bodies 25 are dispersed in the form of columns in the insulating layer 24 and individually extend at right angles to the insulating layer 24. Thus, each soft magnetic body 25 extends at right angles to the insulating layer 24 between and in contact with the main and return poles 2 and 3.

For example, an alloy containing iron, nickel, and cobalt may be used for the soft magnetic bodies 25. The soft magnetic bodies 25 and nonmagnetic insulating layer 24, like granular media, are manufactured by the sputtering or co-sputtering process. In the sputtering process, sintered bodies containing a nonmagnetic insulating material and soft magnetic material are individually target-deposited and naturally separated. In the co-sputtering process, two targets, a nonmagnetic insulating material and soft magnetic material, are simultaneously sputtered.

As shown in FIG. 3, a protective insulating film 79 entirely covers the reproduction head 54 and recording head 56 constructed in this manner except for those parts which are exposed in the ABS 43 of the slider 42. The insulating film 79 defines the contour of the head section 44.

When the VCM 16 is activated, according to the HDD constructed in this manner, the head actuator 14 pivots, whereupon each magnetic head 33 is moved to and positioned on a desired track of the magnetic disk 12. Further, the magnetic head 33 is caused to fly by airflow C that is produced between the disk surface and the ABS 43 as the magnetic disk 12 rotates. When the HDD is operating, the ABS 43 of the slider 42 is opposed to the disk surface with a gap therebetween. As shown in FIG. 2, the magnetic head 33 is caused to fly in an inclined posture such that the recording head 56 of the head section 44 is located closest to the surface of the disk 12. In this state, the reproduction head 54 reads recorded data from the disk 12, while the recording head 56 writes data to (records a signal on) the disk.

In writing data, an alternating current is passed through the recording coil 5 of the recording head 56, whereupon the data is written to the magnetic recording layer 103 of the magnetic disk 12 by means of a magnetic field from the distal end surface of the main pole 2 on the ABS side. When or before the recording coil 5 is energized, moreover, current Iop from the current source 80 is passed through an electrical circuit in which the main and return poles 2 and 3 are connected in series. In this way, a direct current is passed through the spin-torque oscillator 74 to produce a high-frequency magnetic field, which is applied to the perpendicular magnetic recording layer 103 of the disk 12. Magnetic recording can be achieved with high retention force and high magnetic anisotropic energy by superposing the high-frequency magnetic field on the recording magnetic field.

According to the recording head constructed in this manner, magnetic flux due to the energization of the recording coil 5 is produced between the main and return poles 2 and 3 through the soft magnetic bodies 25 in the junction 4. Therefore, magnetic field strength A at a magnetic gap portion of the ABS 43 increases. Further, a high electrical resistance at the junction 4 can suppress current through the junction 4, thereby enabling sufficient current for the oscillation of the spin-torque oscillator 74 to flow between the return pole 3 and the distal end portion 2a of the main pole 2. In this way, a satisfactory gap magnetic field and current in the oscillator 74 can produce a satisfactory magnetic field distribution for recording on the magnetic disk 12, thereby achieving a high-quality recording state. Thus, a high linear recording density can be achieved for the magnetic disk.

FIG. 10 comparatively shows effects of the write current dependence of bit-error rates obtained when recording and reproduction are performed by using the magnetic head according to the first embodiment and a head according to Comparative Example 1. In Comparative Example 1, a junction 4 of a recording head consists mainly of a nonmagnetic insulating material.

Since the junction 4 in the magnetic head of Comparative Example 1 comprises the nonmagnetic insulating material, a magnetic circuit is divided at the junction, so that magnetic flux is impeded. As shown in FIG. 10, therefore, the magnetic head of Comparative Example 1 cannot provide sufficient magnetic field strength even when supplied with a high current, and therefore, cannot improve the error rate. According to the magnetic head of the present embodiment, in contrast, the junction 4 of the recording head can achieve sufficient magnetic field strength by means of the columnar soft magnetic bodies 25 of high saturated magnetic flux density dispersed in the insulating material. Thus, sufficient write capability can be obtained at low current, so that the error rate can be improved.

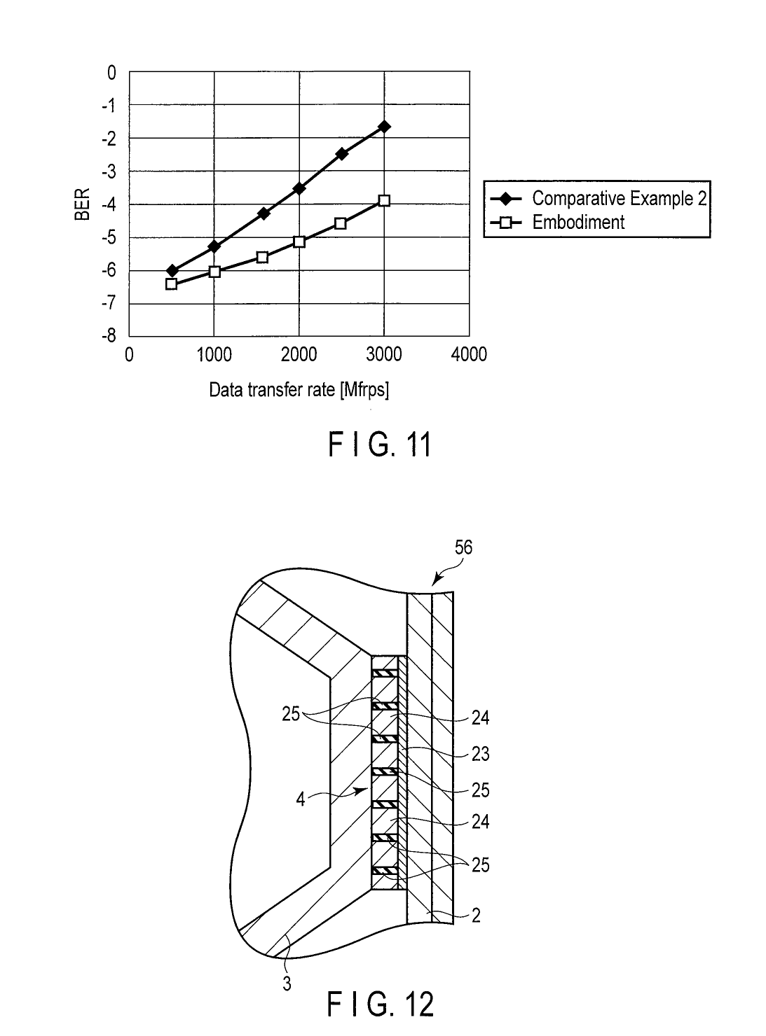

FIG. 11 comparatively shows effects of the write current dependence of bit-error rates obtained when recording and reproduction are performed by using the magnetic head according to the first embodiment and a head according to Comparative Example 2. In Comparative Example 2, a junction 4 of a recording head consists mainly of a ferromagnetic oxide such as ferrite.

Since the junction 4 in the magnetic head of Comparative Example 2 comprises the ferromagnetic oxide, the saturated magnetic flux density is so low that magnetic flux is impeded. As shown in FIG. 11, therefore, the magnetic head of Comparative Example 2 cannot improve the dependence of the bit-error rate on the data transfer rate. According to the magnetic head of the present embodiment, in contrast, the junction 4 of the recording head can secure a satisfactory magnetic circuit by means of the columnar soft magnetic bodies 25 of high saturated magnetic flux density dispersed in the insulating material. Therefore, the magnetic flux is less impeded than in Comparative Example 2, so that the data-transfer-rate dependence can be improved.

According to the present embodiment, moreover, the junction 4 of the recording head can be formed into a thin layer, since a material with sufficient saturated magnetic flux density can be selected for it and it can be easily manufactured by sputtering.

The following is a description of magnetic heads of HDDs according to alternative embodiments. In the description of these alternative embodiments to follow, like reference numbers are used to designate the same parts as those of the first embodiment, and a detailed description thereof is omitted.

### Second Embodiment

FIG. 12 is a sectional view showing a junction of a recording head of an HDD according to a second embodiment.

According to the second embodiment, as shown in FIG. 12, a junction 4 of a recording head 56 comprises a nonmagnetic insulating layer 24 and a large number of soft magnetic bodies 25. The insulating layer 24 is arranged between the main and return poles 2 and 3 and physically connects these poles. The soft magnetic bodies 25 are included in the insulating layer 24. In the present embodiment, the soft magnetic bodies 25 are dispersed in the form of columns in the insulating layer 24 and individually extend at right angles to the insulating layer 24. Thus, each soft magnetic body 25 extends at right angles to the insulating layer 24 between the main and return poles 2 and 3 and is exposed in both surfaces of the insulating layer. Further, the junction 4 comprises a high-resistance layer 23 of a high-resistance material sandwiched between the insulating layer 24 and main pole 2. Thus, the electrical resistance at the junction 4 is higher than between the main and return poles between which a spin-torque oscillator is interposed. The high-resistance layer 23 is sufficiently thinner than the nonmagnetic insulating layer 24.

For example, permalloy or an alloy containing iron, nickel, and cobalt may be used for the soft magnetic bodies 25. A semiconductor based on silicon or the like or a nonmagnetic material, such as ruthenium, tantalum, alumina, etc., may be used as the high-resistance material that forms the high-resistance layer 23.

According to the recording head 56 comprising the junction 4 constructed in this manner, magnetic flux produced by energization of a recording coil 5 is produced between the main and return poles 2 and 3 through the soft magnetic bodies 25 in the junction 4. Therefore, the magnetic field strength at a magnetic gap portion of an ABS increases. Further, high electrical resistances in the high-resistance layer 23 of the junction 4 and the underlayer of the magnetic disk can suppress current through the junction, thereby enabling sufficient current to flow through the spin-torque oscillator. A satisfactory gap magnetic field and current in the spin-torque oscillator can produce a satisfactory magnetic field distribution for recording on the magnetic disk, thereby achieving a high-quality recording state. Thus, a high linear recording density can be achieved for the disk.

In forming a magnetic circuit that assures sufficient write magnetic field strength, a saturated magnetization value at the junction 4 is preferably be about 1.5 T or more, which is nearly equal to those of the main and return poles 2 and 3. In the embodiment described above, a saturated magnetization value of 1.5 T or more is secured at the junction by means of the soft magnetic bodies dispersed in the insulating layer 24 of the junction. Further, electrical insulation is achieved by the high-resistance layer 23 of a high-resistance material so that sufficient current can be passed through the spin-torque oscillator.

### Third Embodiment

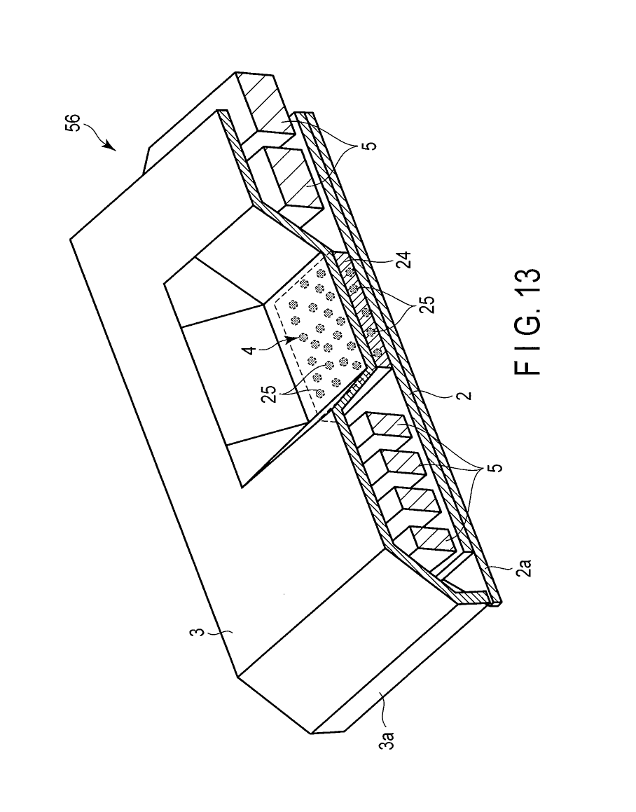

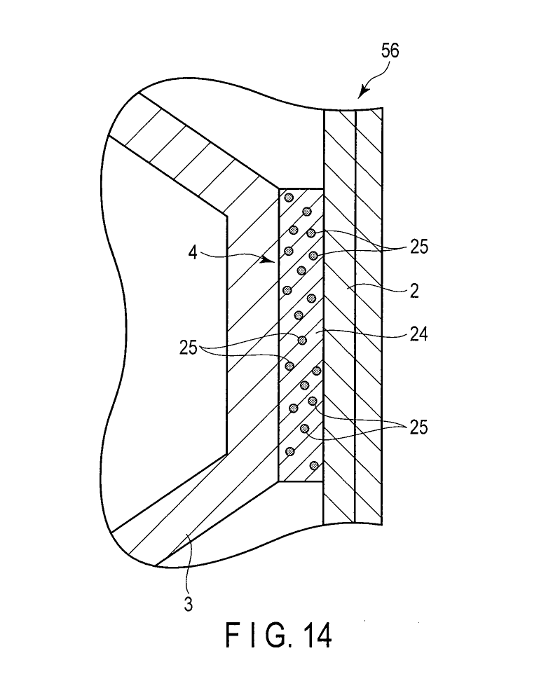

FIG. 13 is a cutaway perspective view showing a recording head of an HDD according to a third embodiment, and FIG. 14 is an enlarged sectional view showing junction of the recording head.

According to the third embodiment, as shown in FIGS. 13 and 14, a junction 4, which connects the respective upper or rear portions of main and return poles 2 and 3, comprises a nonmagnetic insulating layer 24 and a large number of soft magnetic bodies 25. The insulating layer 24 is arranged between and in surface contact with the main and return poles and physically connects the poles. The soft magnetic bodies 25 are included in the insulating layer 24. The soft magnetic bodies 25 are dispersed throughout the insulating layer 24. For example, an alloy containing iron, nickel, and cobalt may be used for the soft magnetic bodies 25.

According to the recording head 56 constructed in this manner, magnetic flux produced by energization of a recording coil 5 is produced between the main and return poles 2 and 3, passing through the soft magnetic bodies 25 in the junction 4. Therefore, the magnetic field strength at a magnetic gap portion of an ABS increases. Further, a high electrical resistance of the nonmagnetic insulating layer 24 in the junction 4 can suppress current through the junction, thereby enabling sufficient current for the oscillation of a spin-torque oscillator to flow. In this way, a satisfactory gap magnetic field and current in the spin-torque oscillator can produce a satisfactory magnetic field distribution for recording on the magnetic disk, thereby achieving a high-quality recording state. Thus, a high linear recording density can be achieved for the disk.

According to the present embodiment, the magnetic circuit can be secured by means of the granular soft magnetic bodies of high saturated magnetic flux density dispersed in the insulating material, and sufficient magnetic field strength can be obtained. Therefore, the error rate and data-transfer-rate dependence can be improved. Since the main and return poles are electrically insulated from each other by the nonmagnetic insulating layer, moreover, sufficient current can be passed through the spin-torque oscillator. In the third embodiment, the junction 4 may comprise the high-resistance layer described in connection with the second embodiment.

According to the embodiments described in detail herein, there may be provided a magnetic head, with which the quality of recording on the recording medium and the linear recording density can be improved, and a disk drive provided with the same.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the materials, shapes, sizes, etc., of the constituent elements of the head section may be changed if necessary. In the magnetic disk drive, moreover, the numbers of magnetic disks and heads can be increased as required, and the disk size can be variously selected.

What is claimed is:

1. A recording head for perpendicular recording, comprising:
a main pole configured to apply a recording magnetic field to a recording layer of a recording medium;
a return pole opposed to the main pole with a write gap therebetween and configured to form a magnetic circuit in conjunction with the main pole;
a junction formed of a nonmagnetic body in which soft magnetic bodies are dispersed and configured to physically connect the main and return poles to each other;
a coil configured to excite the magnetic flux in the magnetic circuit;
a spin-torque oscillator arranged between the return pole and an end portion of the main pole and configured to produce a high-frequency magnetic field;
and a current source configured to supply a current to the spin-torque oscillator through the return and main poles.

2. The recording head of claim 1, wherein the junction comprises a nonmagnetic insulating layer interposed between the main and return poles and columnar soft magnetic bodies dispersed in the nonmagnetic insulating layer.

3. The recording head of claim 2, wherein the columnar soft magnetic bodies individually extend at right angles to the nonmagnetic insulating layer and contact the main and return poles.

4. The recording head of claim 1, wherein the junction comprises a nonmagnetic insulating layer interposed between the main and return poles and granular soft magnetic bodies dispersed in the nonmagnetic insulating layer.

5. The recording head of claim 4, wherein the junction comprises a high-resistance layer interposed between the nonmagnetic insulating layer and the main pole.

6. The recording head of claim 2, wherein the junction comprises a high-resistance layer interposed between the nonmagnetic insulating layer and the main pole.

7. A disk drive comprising:
a disk-shaped recording medium comprising a magnetic recording layer having a magnetic anisotropy perpendicular to a surface of the medium;
a mechanical module configured to rotate the recording medium; and
a magnetic head comprising a slider and a recording head arranged on one end portion of the slider and configured to process data on the recording medium,
the recording head comprising
a main pole configured to apply a recording magnetic field to the recording layer of the recording medium;
a return pole opposed to the main pole with a write gap therebetween and configured to form a magnetic circuit in conjunction with the main pole;
a junction formed of a nonmagnetic body in which soft magnetic bodies are dispersed and configured to physically connect the main and return poles to each other;
a coil configured to excite the magnetic flux in the magnetic circuit;
a spin-torque oscillator arranged between the return pole and an end portion of the main pole and configured to produce a high-frequency magnetic field; and
a current source configured to supply a current to the spin-torque oscillator through the return and main poles.

8. The disk drive of claim 7, wherein the junction comprises a nonmagnetic insulating layer interposed between the main and return poles and columnar soft magnetic bodies dispersed in the nonmagnetic insulating layer.

9. The recording head of claim 8, wherein the columnar soft magnetic bodies individually extend at right angles to the nonmagnetic insulating layer and contact the main and return poles.

10. The recording head of claim 7, wherein the junction comprises a nonmagnetic insulating layer interposed between the main and return poles and granular soft magnetic bodies dispersed in the nonmagnetic insulating layer.

11. The recording head of claim 10, wherein the junction comprises a high-resistance layer interposed between the nonmagnetic insulating layer and the main pole.
